(19) United States
(12) Patent Application Publication
(10) Pub. No.: US 2025/0084949 A1
(43) Pub. Date: Mar. 13, 2025

(54) Thread Protector

(71) Applicant: Radim Zvak, Addison, IL (US)

(72) Inventor: Radim Zvak, Addison, IL (US)

(21) Appl. No.: 18/367,975

(22) Filed: Sep. 13, 2023

(51) Int. Cl. F16L 57/00

(52) U.S. Cl. CPC F16L 57/005

(57) ABSTRACT

The thread protector formed of a wire wound to form a helical portion having a proximal end, a distal end, a thread side, a protected side disposed at a protected diameter. The thread protector adapted to threadably engage the inside threads of a threaded inlet such as a clean-out used in piping systems defining a threaded passageway. The thread side disposed on a flank of the inside thread. The protected diameter smaller than the minor diameter of the threaded inlet whereby a protected passageway is formed along the protected side of the helical portion. The protected side spaced from a peak of the inside thread.

### FIELD OF THE INVENTION

The present invention relates generally to a thread protector for use with a drain or pipe clean-out specifically in a pipe of frangible material such as PVC.

### DESCRIPTION OF RELATED ART

Working on piping systems involves joining sections of pipe together to make a piping circuit to provide fluid communication to transfer liquids between a source and a destination. Sections of pipe are fitted with threaded junctions to facilitate assembly into a piping system. The threaded connections may comprise fittings having male and female threaded openings for attaching to pipe ends or, the threaded connection may be molded into the pipe sections. Once in place, piping systems may become clogged by foreign material introduced into the system and must be cleaned. A pipe connection referred to as a pipe clean-out may provide access to the interior of a piping system by a threaded opening inserted into the pipe circuit. The threaded opening may have a plug that threadably closes the clean-out opening when liquids are transferred. When access is needed into the piping circuit, the plug may be removed and tools inserted into the cleanout for extension into the pipe. Tools may include end effectors such as hair and grease grabbers, cameras, hooks or rams connected to the outside by cables or rods extending through the threaded opening. The cables or rods may damage the female threads on the cleanout by rubbing as the tool is moved into position. A thread protector may be needed to be placed onto the threads to prevent such damage. Prior art thread protectors may be a threaded bushing threadably engaged in the female threaded opening which have the disadvantages of reducing the diameter of the workable opening of the cleanout thus limiting the size of the tools that maybe used, and, the busing may get jammed, making the thread protector hard to remove.

Pipe systems may be formed of a variety of diameters depending on the use and the volume of material to be transferred. A different thread protector is required for each size pipe used. In addition, thread patterns are different depending on the type of materiel. For example, a 2 inch PVC pipe thread may be different from a 2 inch iron pipe thread. Therefore, a different thread protector may be needed for each type and size of material used. There is a need for a thread protector device that is adaptable in the field to the particular thread pattern needed to allow a technician to quickly secure the threads before inserting tools into a clean-out

These prior art devices have failed to properly and efficiently address this problem with working on piping systems. There exists a need for a thread protector that may change diameters and adapt to different thread patterns. Furthermore, there is a need for a thread protector that is lightweight, easy to install and easy to remove.

### BRIEF DESCRIPTION OF THE PRESENT INVENTION

The present invention is a thread protector formed of wire having a helix portion that may be manipulated to change the diameter and pitch of the helical coil. The wire thread protector may be threaded into the threaded opening of a piping system cleanout while the resiliency of the wire urges the helix portion to adapt itself to the diameter and pitch of the threads. The thread protector has an outer surface that is urged into contact with the flanks of the threads by the resilient nature of the helix shaped wire coil. The thread protector may be formed of a wire having a diameter sufficient to form a protected opening wherein the peaks of the threads are spaced from the protected opening. That is, the helix portion may have an inner diameter and an outer diameter, the outer diameter being larger than the thread diameter. When the helix portion is compressed by rotating a proximal end with respect to a distal end, the outer diameter is reduced to allow insertion into the cleanout opening. The helix portion may be inserted by threading into the cleanout opening. Releasing the compression may cause the resiliency of the wire to urge the outer surface into contact with the threads. The helix portion is adapted to urge the outer surface of the wire in to the space between adjacent internal threads thereby surrounding the cleanout opening. The wire diameter may be large enough to dispose the internal surface of the helix portion along a diameter that is smaller than the internal diameter of the internal threads. The resilient nature of the wire holds the thread protector in place providing a work surface spaced from the thread tip. The thread protector may be threaded out of the threaded opening when the work is finished, without damaging the threads. A wire of sufficient diameter is selected from materials of metal, or plastic. A memory shaped material such a Nitinol® may be used to regain shape in thread protectors that are used in tight work spaces where removal may distort the helical portion of the thread protector.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a perspective view of a thread protector configured in accordance with the present invention;

FIG. 2 is a perspective view of a clean-out

FIG. 3 is a perspective view of the thread protector of FIG. 1 in the threaded opening of the clean-out of FIG. 2.

FIG. 4 is a front view of thread protector of FIG. 1 in a clean-out

FIG. 5 is a section view taken at approximately 5-5 of FIG. 4.

FIG. 6 is a front view of the thread protector of FIG. 1 decompressed to increase the external diameter.

FIG. 7 is a front view of the thread protector of FIG. 1 compressed to reduce the external diameter.

### DETAILED DESCRIPTION OF THE PREFERRED EMBODIMENT

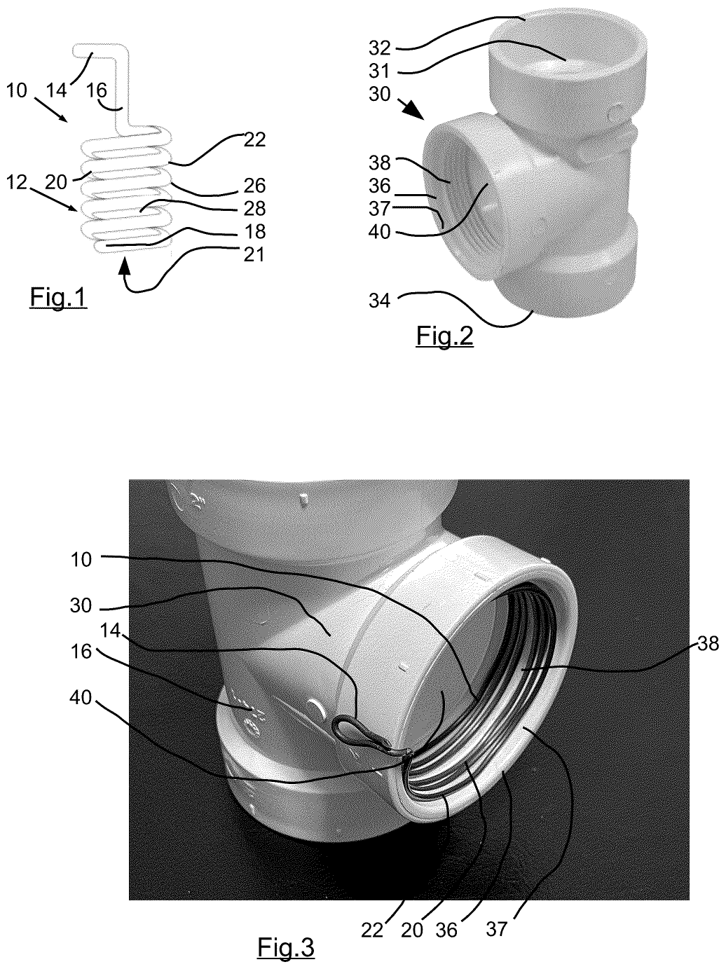

Referring now to the drawings, FIG. 1 is a perspective view of the thread protector 10 configured in accordance with the present invention. The thread protector 10 comprises a body 12 and a handle 14. The body 12 further comprises a proximal end 16, a distal end 18 and helical portion 20. The handle 14 may be on the proximal end 16 spaced from the helical portion 20. The helical portion 20 is formed of a wire 22 wound in a helix shape. The wire 22 may be metal or plastic. Hollow core 21 is formed inside helical portion 20. The helical portion 20 may have a thread side 26 and a tool side 28. Tool side surrounds hollow core 21.

Referring to FIGS. 2 and 3, a clean-out 30 may comprise an interior 31, input 32, an output 34 and an access opening 36. It should be understood, the input 32 and output 34 may be switched with no effect on the present invention. The access opening 36 may have an outer lip 37 and internal threads 38 surrounding the passageway 40. The passageway 40 is in fluid communication with the interior 31, input 32 and the output 34. The thread protector 10 is threaded into the access opening 36 having the helical portion 20 on the internal threads 38. The handle 14 is spaced from the access opening 36. The proximal end 16 may be adjacent to the outer lip 37 and the distal end 18 extending into the passageway 40, the tool side 28 surrounding passageway 40.

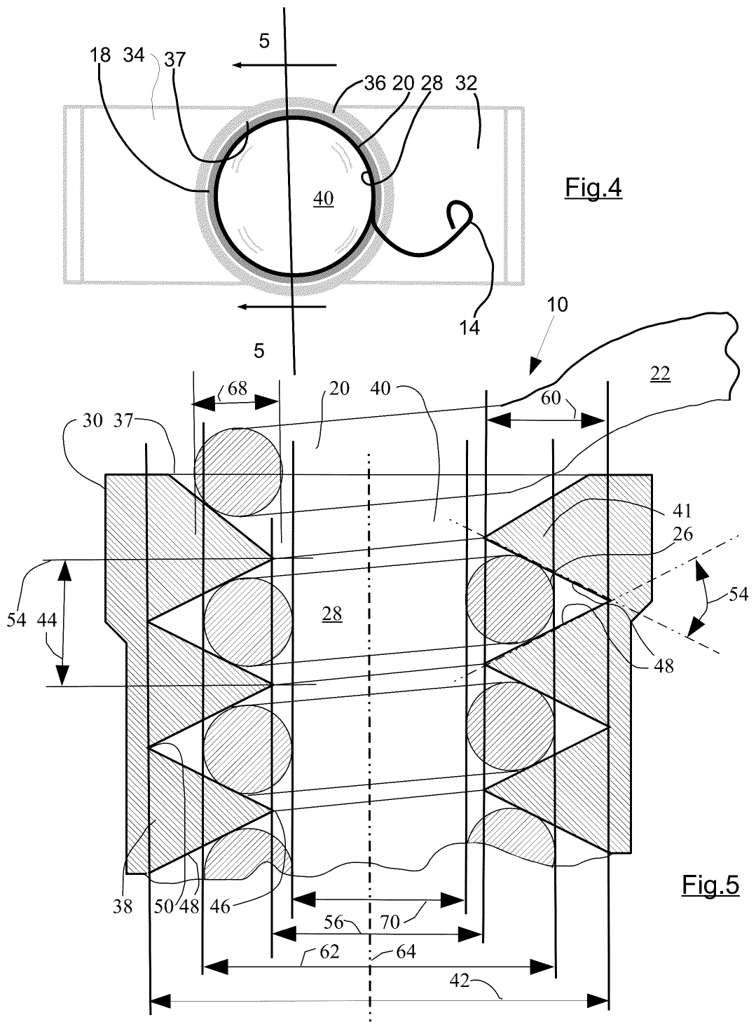

Referring to FIG. 4, the thread protector 10 is threaded into the access opening 36 having the helical portion 20 in the passageway 40. Handle 14 is disposed out of the way and off to the side of the access opening 36. Tool side 28 surrounds passageway 40 from the outer lip 37 and extending into the clean-out 30.

Referring to FIG. 5, each internal thread 41 in the series of internal threads 38 is characterized by its major diameter 42 and its pitch 44. The internal thread 41 may be a symmetric V-shaped thread as shown. The internal thread 41 may comprise a peak 46, a flank 48, a root 50 and a plane 52 of the internal thread 41. The flanks 48 may be disposed at an angle 54 to each other. The flanks 48 may be flat, concave or convex depending on the thread design. The pitch 44 is the distance between thread peaks 46. The thread peaks 46 surround the passageway 40. Threads 38 may be characterized by a minor diameter 56, pitch diameter 58 and thread depth 60. The minor diameter 56 is the threaded diameter 56 measured from peak 46 to peak 46.

Continuing to refer to FIG. 5, the pitch diameter 62 of a particular internal thread 41 is the diameter of a cylindrical surface, axially concentric to the internal thread 41, which intersects the thread flanks 48 at equidistant points at 50% of the thread depth 60, when viewed in a cross-sectional plane containing the cleanout axis 64. In the illustration of FIG. 5, the pitch diameter 62 is approximately equal to the protected diameter 66 defined by the diameter of the protected side 28 surrounding the passageway 40. Thread protector 10 comprises wire 22 having a diameter 68. The external thread side 26 may be spaced from the internal tool side 28 by the wire diameter 68. Tool side 28 surrounds passageway 40 wherein the wire 22 bears on the flank 48 of adjacent threads 41. Helical portion 20 further comprises a protected diameter 70 defined by the diameter about axis 64 of the protected side 28. When installed in the clean-out 30, passageway 40 comprises a protected diameter 70 defined by tool side 28, which is less than minor diameter 56 defined between between thread peaks 46. The tool side 28 extends along the passageway 40.

Continuing to refer to FIG. 5, the threads 38 may be straight threads wherein the roots 50 are disposed in a cylindrical shape along the passageway 40 or, alternatively, threads 38 may be disposed in a tapered relationship wherein the major diameter 42 and the minor diameter 56 increase from adjacent to the outer lip 37 to a point along passageway 40 forming a conical shape. Wire 22 may have an outside diameter 68 large enough to rest between adjacent flanks 48 having tool side 28 forming protected diameter 70 of passageway 40. The thread protector 10 comprising wire 22 made of resilient material having a spring elasticity. Helical portion 20 is formed at a diameter to urge the from the distal end 18 to proximal end 16 to expand at each turn of the helical portion 20 to bear against the to the flank 48.

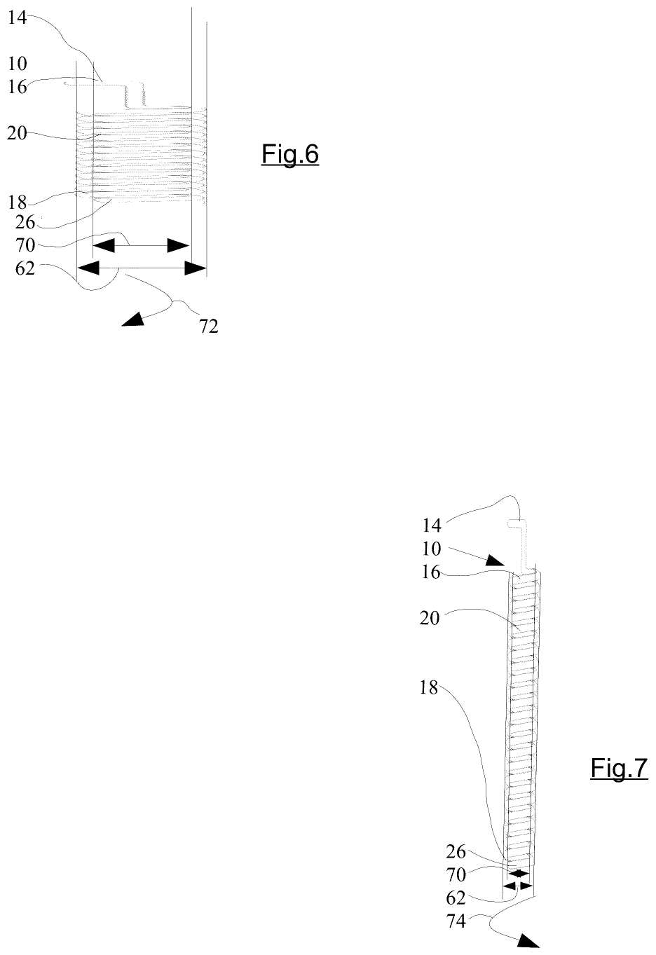

Referring to FIGS. 6 and 7, the thread protector may have an outer diameter 62 at rest that is larger than minor diameter 56. Helical portion 20 may be compressed, reducing outer diameter 62, by twisting proximal end 16 with respect to distal end 18 in a first direction 72 to increase the number of windings 73 for insertion into the threaded opening. Upon insertion, the distal end 18 may be released whereby the spring tension of the compressed helical portion 20 may urge the distal end to rotate in a second direction 74, increasing the outer diameter 62 to urge wire 22 into the space between adjacent flanks 48.

While specific embodiments have been shown and described to point out fundamental and novel features of the invention as applied to the preferred embodiments, it will be understood that various omissions and substitutions and changes of the form and details of the invention illustrated and in the operation may be done by those skilled in the art, without departing from the spirit of the invention.

1. A thread protector for use with a clean-out, the clean-out comprising an input, an output and an access opening, the access opening comprising threads surrounding a passageway, the passageway comprising a minor diameter, the thread protector comprising:
a body, the body comprising a helical portion, a proximal end and a distal end, the helical portion comprising a wire wound into a helix shape, the helix shape extending from the proximal end to the distal end, the helical portion comprising a thread side and a tool side, the thread side disposed at an outer diameter, the outer diameter larger than the minor diameter; and
a handle, the handle on the proximal end.

2. The thread protector of claim 1, wherein the body comprises a metal wire.

3. The thread protector of claim 2, wherein the body comprises a Nitinol® wire.

4. The thread protector of claim 1, wherein the body comprises a plastic wire.

5. The thread protector of claim 1, wherein the outer diameter is adjustable by rotation of the distal end with respect to the proximal end.

6. A thread protector comprising:
a clean out, the clean out comprising an input, an output, an interior and an access opening, the access opening comprising an outer lip, and a passageway, the passageway comprising a threaded wall comprising a thread extending from the outer lip to the interior, the passageway in fluid communication with the interior, the thread comprising a thread depth, a peak, a root and a flank, the thread disposed around the passageway from the outer lip to the interior, the root on the cleanout, the peak extending inward from the root, the flank disposed between the root and the peak, the flank comprising a flank length;
a body, the body comprising a helix portion comprising a wire wound to form a hollow core, a distal end and a proximal end, the wire wound in a helix shape having a tool diameter, the wire disposed on the flank, the hollow core extending from the outer lip to the interior, the wire comprising a wire diameter, the wire diameter smaller than the thread depth; and
a handle, the handle on the proximal end.
